(19) United States
(12) Patent Application Publication
(10) Pub. No.: US 2015/0188454 A1
(43) Pub. Date: Jul. 2, 2015

(54) INVERTER DEVICE, CONTROL CIRCUIT FOR INVERTER DEVICE, AND METHOD FOR CONTROLLING INVERTER DEVICE

(71) Applicant: SANYO ELECTRONIC CO., LTD., Osaka (JP)

(72) Inventors: Yoshinori NORITAKE, Ohizumi-machi (JP); Kiyoma YAMAGISHI, Itakura-machi (JP)

(21) Appl. No.: 14/580,197

(22) Filed: Dec. 22, 2014

(30) Foreign Application Priority Data
Dec. 27, 2013 (JP) 2013-271278
Nov. 10, 2014 (JP) 2014-228132

(51) Int. Cl. H02M 7/5387; H02M 1/42

(52) U.S. Cl. CPC H02M 7/53871; H02M 1/4233

(57) ABSTRACT

An inverter device converts a DC power into a three-phase AC power and superimposes the AC power on a power grid. A method for controlling the inverter device includes: obtaining, when the three-phase AC power is formed to contain a reactive power having a same amount in each of phases of the three-phase AC power, frequencies of respective phases of the power grid as present frequencies; controlling the reactive power to be contained in each of the phases to have a same amount such that the frequencies further increase when the present frequencies are higher than previous frequencies which have been obtained before the present frequencies are obtained, and such that the frequencies further decrease when the present frequencies are lower than the previous frequencies; and detecting a power outage state of the power grid based on the present frequencies of the respective phases and the previous frequencies.

### BACKGROUND

1. Technical Field

Aspects of the invention relates to an inverter device, a control circuit for the inverter device, and a method for controlling the inverter device.

2. Description of Related Art

There is an inverter device that converts an output of a DC (direct current) power source (solar cell, storage (battery), or the like) into AC (alternating current) power and superimposes the AC power on a power grid through a relay's armature. In order to prevent the AC power from being superimposed on the power grid (a so-called isolated operation) in a power outage of the power grid, the inverter device has a function of opening the relay's armature in the power outage to cut off linkage with the power grid. Thus, when the power outage occurs, it is possible to safely perform repair work in a state where power does not remain in the power grid.

As a method for detecting the isolated operation, JP-A-H 10-215521 describes a method for controlling non-utility generation equipment, which includes: increasing an advanced reactive power of the power generation equipment when a frequency change rate is a positive value, and increasing a delayed reactive power thereof when the frequency change rate is a negative value; and detecting frequency variation promoted by the power increase.

In the method for detecting the isolated operation described above, if a possibility of the isolated operation is detected from the frequency change rate, the volume of the reactive power to be output from the power generation equipment is determined based on the frequency change rate (e.g., as the frequency change rate is high, the reactive power becomes large). If the possibility of the isolated operation is high (i.e., if the frequency change rate is high), it is determined that the isolated operation is performed, and the relay's armature is opened. Thus, the isolated operation is detected in a short time.

### SUMMARY

However, the method for detecting the isolated operation described in JP-A-H10-215521 is applied to an isolated-phase power grid. In contrast, in a three-phase power grid, frequencies of respective three phases may be slightly different from one another. Therefore, when the method is attempt to to be applied to the three-phase power grid, since the determination of the isolated operation is different in each phase, it takes time to finally detect an isolated operation (or it is not possible to detect the isolated operation).

Aspects of the present invention have been made in view of the above-described circumstances, and an object thereof is to provide an inverter device linked with a three-phase power grid, a control circuit for the inverter device, and a method for controlling the inverter device, which can quickly detect an isolated operation.

An aspect of the present invention provides an inverter device which converts a DC power into a three-phase AC power and superimposes the three-phase AC power on a power grid, the inverter device including: a frequency detecting unit which obtains, when the three-phase AC power is formed to contain a reactive power having a same amount in each of phases of the three-phase AC power, frequencies of respective phases of the power grid as present frequencies; a reactive power control unit which controls the reactive power to be contained in each of the phases to have a same amount such that the frequencies further increase when the present frequencies are higher than previous frequencies which have been obtained before the present frequencies are obtained, and such that the frequencies further decrease when the present frequencies are lower than the previous frequencies; and an isolated operation detecting unit which detects a power outage state of the power grid based on the present frequencies of the respective phases and the previous frequencies.

Another aspect of the present invention provides a control circuit for an inverter device which converts a DC power into a three-phase AC power and superimposes the three-phase AC power on a power grid, the control circuit including: a memory which stores instructions; and at least one processor which executes the instructions to cause the control circuit to provide: a frequency detecting unit which obtains, when the three-phase AC power is formed to contain a reactive power having a same amount in each of phases of the three-phase AC power, frequencies of respective phases of the power grid as present frequencies; a reactive power control unit which controls the reactive power to be contained in each of the phases to have a same amount such that the frequencies further increase when the present frequencies are higher than previous frequencies which have been obtained before the present frequencies are obtained, and such that the frequencies further decrease when the present frequencies are lower than the previous frequencies; and an isolated operation detecting unit which detects a power outage state of the power grid based on the present frequencies of the respective phases and the previous frequencies.

Yet another aspect of the present invention provides a method for controlling an inverter device which converts a DC power into a three-phase AC power and superimposes the three-phase AC power on a power grid, the method including: obtaining, when the three-phase AC power is formed to contain a reactive power having a same amount in each of phases of the three-phase AC power, frequencies of respective phases of the power grid as present frequencies; controlling the reactive power to be contained in each of the phases to have a same amount such that the frequencies further increase when the present frequencies are higher than previous frequencies which have been obtained before the present frequencies are obtained, and such that the frequencies further decrease when the present frequencies are lower than the previous frequencies; and detecting a power outage state of the power grid based on the present frequencies of the respective phases and the previous frequencies.

According to aspects of the present invention, it is possible to provide an inverter device linked with a three-phase power grid, a control circuit for the inverter device, and a method for controlling the inverter device, which can quickly detect an isolated operation.

### BRIEF DESCRIPTION OF THE DRAWINGS

FIG. 1 is a diagram illustrating a circuit configuration of an inverter device;

FIG. 2 is a functional block diagram of a control circuit;

FIG. 3 is a diagram illustrating a control flow of a reactive power control unit; and

FIG. 4 is a diagram illustrating a frequency difference and a volume of reactive power.

### DETAILED DESCRIPTION

According to embodiments of the present invention, a reactive power to be contained in an AC (alternating current) power output from a three-phase inverter device is controlled based on frequencies of respective phases of a three-phase power grid and reference frequencies (set frequencies or previous frequencies), whereby frequency variation is promoted, and an isolated operation or a power outage is quickly detected.

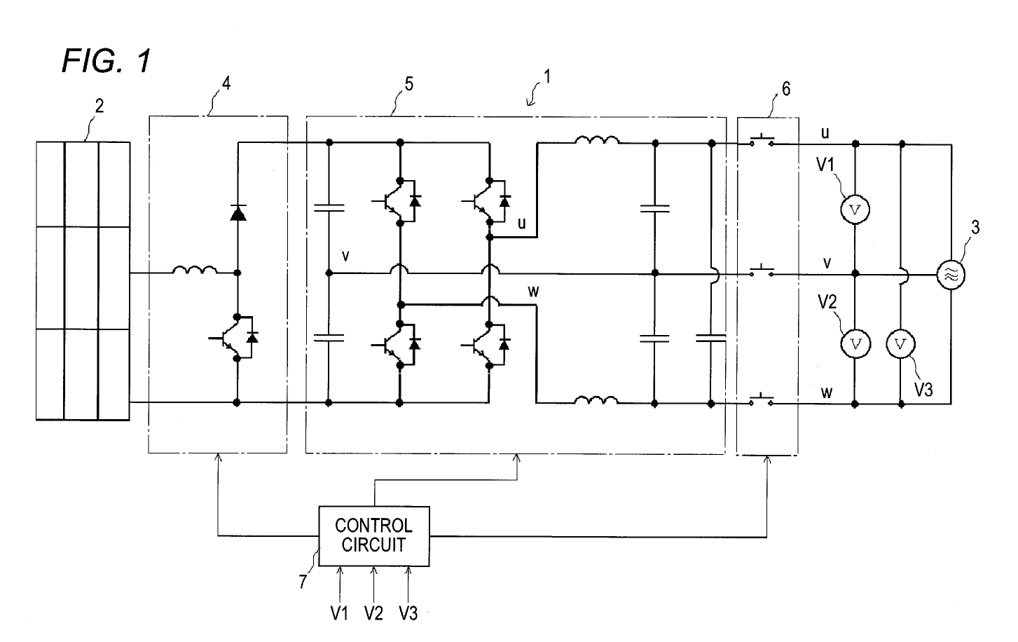

As shown in FIG. 1, an inverter device 1 (a power converter) converts a DC (direct current) power output from a solar cell 2 into a three-phase AC power synchronized with a frequency of a power grid, and superimposes the result on a delta-connected three-phase commercial power grid 3 (a power grid) through a relay's armature 6 (a switch). The inverter device 1 generates a three-phase power by an open delta connection, and then superimposes the three-phase power on the power grid while sequentially passing via a low pass filter formed by a reactor and a capacitor, and the relay's armature 6.

The inverter device 1 includes a booster circuit 4, an inverter circuit 5, and the relay's armature 6 that mainly contribute to the power conversion, sensors (for example, voltage sensors V1 to V3) and the like that mainly contribute to control, and a control circuit 7.

The booster circuit 4 is formed by a non-insulated chopper circuit, and includes a switching element, a boosting reactor, a diode, and a capacitor. The booster circuit 4 boosts a voltage of the solar cell 2 connected to an input side at a desired boosting ratio by turning on or off the switching element at a predetermined duty ratio. The booster circuit is not limited to the chopper circuit, and may be any circuit capable of controlling the boosting ratio, such as a feedback type circuit using an insulated transformer or a ringing choke type circuit. The boosting ratio is controlled so that electricity generated by the solar cell 2 is within an optimal range using a maximum power point tracking (MPPT) control.

The inverter circuit 5 has an input side that is connected to the booster circuit 4, and an output side that is connected to the commercial power grid 3 via the relay's armature 6. The inverter circuit 5 converts the DC power boosted by the booster circuit 4 into the AC power synchronized with the AC power of the commercial power grid 3. The inverter circuit 5 includes a bridge circuit that performs the D/A conversion, and a low pass filter, includes a reactor and a capacitor, that attenuates a high frequency factor of the AC power output from the bridge circuit. The inverter device 1 outputs the converted AC power to three output lines u, v and w of three phases.

The bridge circuit has a configuration in which four switching elements are half-bridge-connected, and outputs a three-phase AC power by an open delta connection in which outputs are connected to the output lines u and w and an intermediate voltage point (connection point of serial connection of two capacitors having the same capacity) of the booster circuit 4 is connected to the output line v. The output of the bridge circuit corresponds to the output of the delta connection of the commercial power grid 3, and if the commercial power grid 3 uses star connection, the bridge circuit employs a three-phase bridge circuit using six switching elements. Further, the bridge circuit may employ a multi-level inverter circuit using a neutral point clamping (NPC) method, a gradation method or the like. The switching elements are turned on or off by a pulse width modulation (PWM) control, for example, to convert the DC power into the AC power.

The relay's armature 6 is a normally opened armature that is disposed to each of the output lines u, v and w of the inverter device 1 connected to the commercial power grid 3 to perform opening or closing of the output lines u, v and w. The inverter device 1 and the commercial power grid 3 are linked to each other when the relay's armature 6 is opened to superimpose the AC power on the commercial power grid 3, and the linkage is released when the relay's armature 6 is opened.

The control circuit 7 includes an arithmetic processing unit such as a microcomputer, and controls the operations of the booster circuit 4, the inverter circuit 5, the relay's armature 6 and the like based on inputs of the sensors. The control circuit 7 performs calculation for performing the D/A conversion, and sends an operation signal to the switching elements of the booster circuit 4 and the inverter circuit 5. Further, the control circuit 7 detects the isolated operation to perform a control for releasing the linkage of the inverter device 1 and the commercial power grid 3.

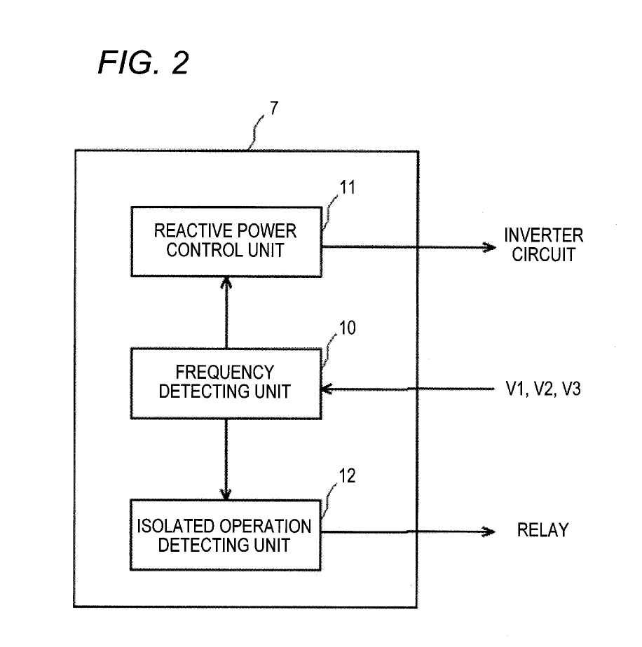

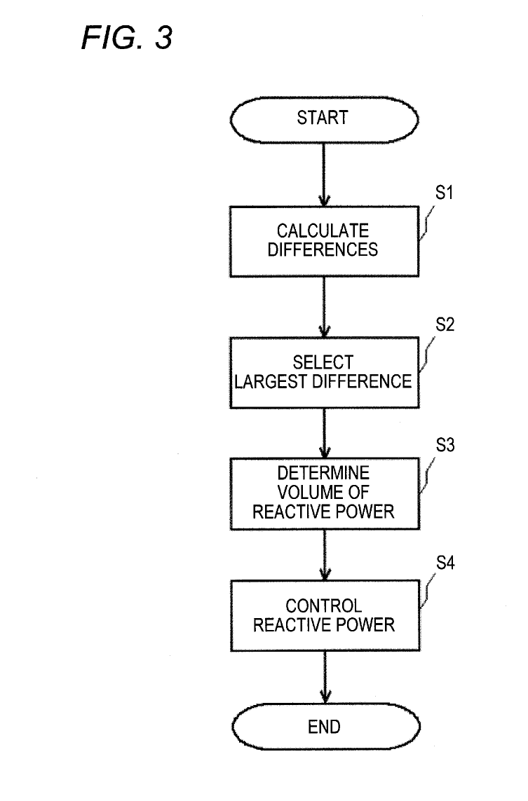

Next, a method for detecting the isolated operation will be described. As shown in FIG. 2, the control circuit 7 includes at least a frequency detecting unit 10, a reactive power control unit 11, and an isolated operation detecting unit 12. In other words, the control circuit 7 may include a memory which stores instructions; and at least one processor which executes the instructions to cause the control circuit 7 to provide at least one of the frequency detecting unit 10, the reactive power control unit 11, and the isolated operation detecting unit 12, or which executes the instructions to cause the control circuit to perform at least one of the processes shown in FIG. 3.

The frequency detecting unit 10 detects line voltages Vuv, Vwv and Vuw between the output lines u, v and w using the voltage sensors V1 to V3 provided on the side of the commercial power grid 3 with reference to the relay's armature 6. Here, the voltages Vuv, Vwv and Vuw are obtained by detection using three voltage sensors V1 to V3, but since the sum of the voltages Vuv, Vwv and Vuw becomes zero in the case of three-phase power, the voltages corresponding to two phases may be obtained by the detection and the voltage of one residual phase may be obtained by calculation.

The frequency detecting unit 10 periodically calculates three phase frequencies fuv, fwv and fuw from the respective detected voltages Vuv, Vwv and Vuw. The frequencies fuv, fwv and fuw may be calculated from a time (cycle) from zero cross to zero cross in the voltage, and or may be calculated by performing phase estimation from an angular velocity of the voltage. The frequencies fuv, fwv and fuw of the respective phases of the three-phase power may be similarly calculated based on electric currents flowing in the output lines u, v and w. When the zero cross of the voltage is used, the values of the frequencies are obtained by calculating the values for each zero cross at each predetermined cycle (180° or 360° in electrical angle), and then, by calculating a moving average a predetermined number of times as a noise countermeasure. The values of the frequencies obtained in this way are used for subsequent control. Further, when the values of the frequencies are calculated by the phase estimation, similarly, the values obtained by performing the calculation at a predetermined cycle and calculating a moving average are used for control.

When the frequencies fuv, fwv and fuw (current frequencies) are higher than frequencies kfuv, kfwv and kfuw detected in the past (or immediately previously), the reactive power control unit 11 performs a control of changing the amount of the reactive power included in the AC power output from the inverter device 1 (inverter circuit 5) so that the frequencies fuv, fwv and fuw further increase. Further, when the frequencies fuv, fwv and fuw are lower than the previously detected frequencies kfuv, kfwv and kfuw, the reactive power control unit 11 performs the reactive power control so that the frequencies fuv, fwv and fuw further decrease. The reactive power control unit 11 performs the reactive power control for each zero cross (for each 60° in electric angle) of each phase of the three-phase power, for example. That is, the amount of the reactive power to be contained in the three-phase AC power output from the inverter device 1 is changed. If a timing when the amount of the reactive power is changed is set for each cycle of the AC power, reactive power may be controlled to have approximately the same amount for each phase. Further, the timing when the reactive power is changed may be appropriately set, and for example, may be set for each arbitrarily set cycle, for each frequency calculation, for each voltage detection, or the like.

Here, if the reactive power control unit 11 performs three/two phase conversion and uses a d-q coordinate system that rotates in synchronization with the three-phase AC power (voltage), since active power (electric current) and reactive power (electric current) of all of the three phases can be independently controlled using the d-q coordinate system, the reactive power control unit 11 directly controls the reactive power of the AC power to be output by the independent control. Command values (which may be collectively referred to as a command vector) of the active power and the reactive power of the entire three phases calculated by the coordinate system become command values of the respective phases of the AC power (including the active power and the reactive power) output from the two/three phase conversion, and the inverter circuit 5 is controlled by the command values, so that the reactive power is contained in all of the plural entire phases. That is, in order to obtain a voltage waveform (modulated wave) that serves as a base of a signal for turning on or off the respective switching elements of the inverter circuit 5, three phase voltage waveforms are converted into two orthogonal phase waveforms on the d-q coordinate system, the phases of the two waveforms are corrected at a rotation angle corresponding to the amount of the reactive power, and then, the two/three phase conversion is performed to obtain corrected voltage waveforms. If a corrected signal for turning on or off is calculated from the voltage waveform (modulated wave) and a carrier wave, the reactive power having the same amount can be contained in each of the phases of the three phases at the same time.

Further, instead of directly controlling the reactive power, a control for changing the reactive power may be performed. For example, when a sine wave (electric current command) before PWM modulation is synchronized with the frequency of the commercial power grid 3, the reactive power may be changed by shifting (advancing or delaying) the synchronization timing. In this case, similarly, the reactive power having the same amount can be contained in each of the phases of the three phases at the same time.

As shown in FIG. 3, the reactive power control unit 11 respectively calculates differences df1 to df3 between the frequencies fuv, fwv and fuw detected by the frequency detecting unit 10 and reference frequencies f1 to f3 (df1=fuv−1, df2=fwv−f2 and df3=fuw−f3) (step S1).

Here, the reference frequencies f1 to f3 may use a basic frequency (for example, 50 Hz or 60 Hz) of the commercial power grid 3, but here it is assumed that the frequencies kfuv, kfwv and kfuw that are detected previously (before a predetermined cycle) are used as the frequencies fuv, fwv and fuw (that is, df1=fuv−kfuv, df2=fwv−kfwv and df3=fuw−kfuw). The frequencies fuv, fwv and fuw, and the previously detected frequencies kfuv, kfwv and kfuw may use one value, or instead, may use an average value, a center value or the like of plural values.

If the differences df1 to df3 of the frequencies are calculated in this way, the reactive power control unit 11 selects the greatest difference from among the differences df1 to df3 between the frequencies fuv, fwv and fuw and the reference frequencies f1 to f3 (step S2). Further, the reactive power control unit 11 determines the volume of the reactive power to be contained in each phase based on the selected difference (step S3), and controls the inverter circuit to become the volume of the determined reactive power (the amount of the reactive power) (step S4). For example, when the difference df1 among the calculated differences df1 to df3 of the frequencies is the largest difference, the volume of the reactive power to be contained in each phase based on the difference df1 is determined.

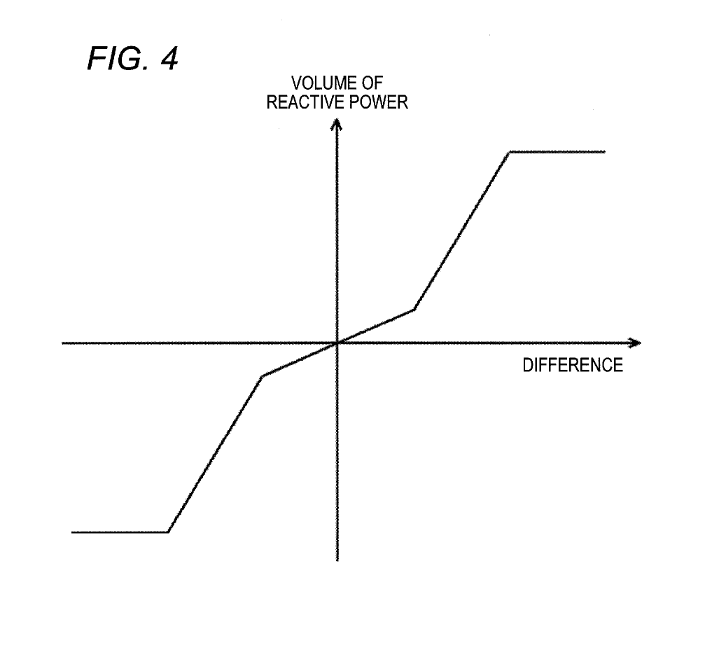

The volume of the reactive power controlled by the reactive power control unit 11 is set to a large value as the volume of the difference (for example, the volume of an absolute value of the difference) is large, and the volume of the reactive power includes an upper limit and a lower limit Specifically, as shown in FIG. 4, when a transverse axis represents the difference, and a longitudinal axis represents the volume of the reactive power output from the inverter device 1, a proportional relation having plural inclinations (gains) is obtained, and a portion where the absolute value of the difference is large has an upper limit and a lower limit. The inclination is set to be small in a portion where the difference is small, and is set to be large in a portion where the difference is large. That is, when the difference is large (probability of isolated operation), the inclination is set so that a larger amount of reactive power can be contained in the AC power.

In this way, the reactive power control unit 11 performs a control so that the AC power including a negative reactive power (that is, delayed reactive power) when the difference is a negative value and a positive reactive power (that is, advanced reactive power) when the difference is a positive value is output from the inverter device 1.

The isolated operation detecting unit 12 detects the isolated operation (power outage state) based on the frequencies fuv, fwv and fuw calculated by the frequency detecting unit 10. Specifically, the isolated operation detecting unit 12 calculates the differences df1 to df3 between the frequencies fuv, fwv and fuw and the reference frequencies f1 to f3. If the differences df1 to df3 are greater than a predetermined threshold value, the isolated operation detecting unit 12 detects that the isolated operation is performed to open the relay's armature 6. Further, if the differences df1 to df3 are less than the predetermined threshold value, since the isolated operation is not performed, the isolated operation detecting unit 12 maintains the connection state of the relay's armature 6 as it is.

As a comparison result of the respective differences df1 to df3 and the threshold value, when any difference is larger than the threshold value, the isolated operation detecting unit 12 may detect that the isolated operation is performed, or when all the differences df1 to df3 exceed the threshold value, the isolated operation detecting unit 12 may detect that the isolated operation is performed. Further, the isolated operation detecting unit 12 may compare the average value or the highest value of the differences df1 to df3 with the threshold value. Further, when the threshold value gradually increases whenever the differences exceed the threshold value, and when the number of the excesses reaches a predetermined number, the isolated operation detecting unit 12 may detect that the isolated operation is performed.

As described above, in the embodiment, the AC power including the reactive power is output from the inverter device 1, and the difference of the frequencies promoted by the output is detected, to thereby detect the isolated operation. In this embodiment, since the volume of the reactive power is changed based on the largest difference among the differences between the frequencies fuv, fwv and fuw and the reference frequencies f1 to f3, a larger amount of reactive power is output when the determination of the isolated operation is performed to promote the difference between the frequencies due to the isolated operation, thereby quickly detecting the isolated operation.

In this embodiment, since the previous frequencies are used as the reference frequencies, even when the frequency of the commercial power grid 3 is deviated from a regulated frequency, the isolated operation can be correctly detected.

In this embodiment, the differences df1 to df3 between the frequencies fuv, fwv and fuw for the respective phases of the three phases and the previous frequencies kfuv, kfwv and kfuw, respectively, are calculated, and the reactive power is controlled based on the largest difference among the differences df1 to df3 calculated for the respective phases of the three phases. Thus, even when deviation occurs due to performance errors of the sensors or the like when the frequencies of the respective phases of the three phases are calculated, the isolated operation can be correctly detected.

As described above, the embodiment of the invention is described, but the above description is made for ease of understanding of the invention, and does not limit the invention. The invention includes modifications or improvements without departing from the scope and spirit of the invention, or includes equivalents thereof.

For example, as the three phase voltages, the voltages between the output lines u, v and w are detected, but when the three-phase connection of the commercial power grid 3 is a star connection, voltages (phase voltages) between a neutral line and the output lines may be detected.

In the embodiment, the differences df1 to df3 are calculated by the reactive power control unit 11 or the isolated operation detecting unit 12, but may be calculated by the frequency detecting unit 10. In this case, the calculated value may be stored in a memory or the like, and may be referenced by the reactive power control unit 11 or the isolated operation detecting unit 12.

In this embodiment, the differences df1 to df3 between the frequencies fuv, fwv and fuw and the previous frequencies kfuv, kfwv and kfuw, respectively, are calculated for the three phase voltages, and the reactive power is controlled based on the largest difference among the differences df1 to df3 calculated for the three phase voltages. However, the volume of the reactive power may be controlled based on a combination having the largest difference among combinations of the differences between each of the frequencies fuv, fwv and fuw each of and the previous frequencies kfuv, kfwv and kfuw for the three phase voltages.

That is, from the differences between the frequency fuv and each of the previous frequencies kfuv, kfwv and kfuw, the differences between the frequency fwv and each of the previous frequencies kfuv, kfwv and kfuw, and the respective differences between the frequency fuw and each of the previous frequencies kfuv, kfwv and kfuw, that is, from the total nine differences, the largest difference may be selected, and the volume of each reactive power may be controlled based on the selected difference.

Further, the volume of the reactive power may be controlled based on (e.g., difference between) the largest value among the frequencies fuv, fwv and fuw and the smallest value among the previous frequencies kfuv, kfwv and kfuw.

Further, the volume of the reactive power may be controlled based on (e.g., difference between) the smallest value among the frequencies fuv, fwv and fuw and the largest value among the previous frequencies kfuv, kfwv and kfuw.

With the configurations, the control width of the reactive power increases, and thus, the isolated operation can be quickly detected.

When forming the AC power of the inverter device 1, the AC power is formed to include the reactive power, but a device for controlling the reactive power may be separately used for control.

Further, for example, in this example, the change of the reactive power is controlled based on the largest difference among the differences (frequency change) between the frequencies fuv, fwv and fuw and the previous frequencies kfuv, kfwv and kfuw for the respective phases of the three-phase power, but the amount of the reactive power to be contained in all the plural phases may be corrected to promote the change of the frequencies fuv, fwv and fuw, based on the value of the largest frequency change among the frequencies fuv, fwv and fuw.

The inverter device 1 of the embodiment may be used as a solar cell system or the like including the solar cell 2.

This application claims priority from Japanese Patent Application No. 2013-271278 filed on Dec. 27, 2013 and Japanese Patent Application No. 2014-228132 filed on Nov. 10, 2014, the entire contents of which are incorporated herein by reference.

1. An inverter device which converts a DC power into a three-phase AC power and superimposes the three-phase AC power on a power grid, said inverter device comprising:
a frequency detecting unit which obtains, when the three-phase AC power is formed to contain a reactive power having a same amount in each of phases of the three-phase AC power, frequencies of respective phases of the power grid as present frequencies;
a reactive power control unit which controls the reactive power to be contained in each of the phases to have a same amount such that the frequencies further increase when the present frequencies are higher than previous frequencies which have been obtained before the present frequencies are obtained, and such that the frequencies further decrease when the present frequencies are lower than the previous frequencies; and
an isolated operation detecting unit which detects a power outage state of the power grid based on the present frequencies of the respective phases and the previous frequencies.

2. The inverter device according to claim 1,
wherein the frequencies of the respective phases are obtained at a predetermined cycle, and
wherein a volume of the reactive power to be contained in the phases is controlled based on a largest value among amounts of increase or decrease of the frequencies of the respective phases.

3. The inverter device according to claim 1,
wherein the frequencies of the respective phases are obtained at a predetermined cycle, and
wherein a volume of the reactive power to be contained in the phases is controlled based on a largest value among differences between each of the present frequencies of the respective phases and each of the previous frequencies of the respective phases which have been obtained before the predetermined cycle.

4. The inverter device according to claim 1,
wherein the frequencies of the respective phases are obtained at a predetermined cycle, and
wherein a volume of the reactive power to be contained in the phases is controlled based on a largest value among the present frequencies of the respective phases and a smallest value among the previous frequencies of the respective phases which have been obtained before the predetermined cycle.

5. The inverter device according to claim 1,
wherein the frequencies of the respective phases are obtained at a predetermined cycle, and
wherein a volume of the reactive power to be contained the phases is controlled based on a smallest value among the present frequencies of the respective phases and a largest value among the previous frequencies of the respective phases which have been obtained before the predetermined cycle.

6. The inverter device according to claim 1,
wherein when a three-phase connection of the three-phase AC power is a delta connection or an open delta connection, the frequencies of the respective phases are obtained as frequencies of voltages or currents between the phases, and
wherein when the three-phase connection of the three-phase AC power is a star connection, the frequencies of the respective phases are obtained as frequencies of voltages or currents between a neutral point and the respective phases.

7. A control circuit for an inverter device which converts a DC power into a three-phase AC power and superimposes the three-phase AC power on a power grid, said control circuit comprising:
a memory which stores instructions; and
at least one processor which executes the instructions to cause the control circuit to provide:
a frequency detecting unit which obtains, when the three-phase AC power is formed to contain a reactive power having a same amount in each of phases of the three-phase AC power, frequencies of respective phases of the power grid as present frequencies;
a reactive power control unit which controls the reactive power to be contained in each of the phases to have a same amount such that the frequencies further increase when the present frequencies are higher than previous frequencies which have been obtained before the present frequencies are obtained, and such that the frequencies further decrease when the present frequencies are lower than the previous frequencies; and
an isolated operation detecting unit which detects a power outage state of the power grid based on the present frequencies of the respective phases and the previous frequencies.

8. A method for controlling an inverter device which converts a DC power into a three-phase AC power and superimposes the three-phase AC power on a power grid, said method comprising:
obtaining, when the three-phase AC power is formed to contain a reactive power having a same amount in each of phases of the three-phase AC power, frequencies of respective phases of the power grid as present frequencies;
controlling the reactive power to be contained in each of the phases to have a same amount such that the frequencies further increase when the present frequencies are higher than previous frequencies which have been obtained before the present frequencies are obtained, and such that the frequencies further decrease when the present frequencies are lower than the previous frequencies; and
detecting a power outage state of the power grid based on the present frequencies of the respective phases and the previous frequencies.
